(19) United States
(12) Patent Application Publication
(10) Pub. No.: US 2015/0149319 A1
(43) Pub. Date: May 28, 2015

(54) PERFORMING MARKETPLACE ACTIONS BASED ON SOCIAL NETWORKING TAGS

(71) Applicant: Amazon Technologies, Inc., Reno, NV (US)

(72) Inventors: Pratik Deepak Pattani, Bellevue, WA (US); Jeetendra Mirchandani, Seattle, WA (US)

(73) Assignee: Amazon Technologies, Inc., Reno, NV (US)

(21) Appl. No.: 14/192,575

(22) Filed: Feb. 27, 2014

Related U.S. Application Data
(60) Provisional application No. 61/907,950, filed on Nov. 22, 2013.

(51) Int. Cl. G06Q 30/06; G06Q 50/00

(52) U.S. Cl. CPC G06Q 30/0633; G06Q 50/01
USPC 705/26.8

(57) ABSTRACT

Aspects of the present disclosure relate to managing a user account based on information received from a social networking service. In accordance with aspects of the present disclosure, a user can associate an account on a social networking service with a separate account on a marketplace system. The marketplace system can define social network tags or identifiers that can be used within the social networking service to implement functions or take actions within the user's account associated with the marketplace system.

### RELATED APPLICATIONS

Any and all applications for which a foreign or domestic priority claim is identified in the Application Data Sheet as filed with the present application are incorporated by reference under 37 CFR 1.57 and made a part of this specification.

### BACKGROUND

A social networking service is a platform to build social networks or social relations among people who, for example, share interests, activities, backgrounds or real-life connections. Many social networking services include a representation of each user (often in the form of a profile), his/her social links or connections and a variety of additional services. Many social networking services are network-based and enable users to interact over the Internet, such as via e-mail and instant messaging. Many social networking services allow users to share ideas, pictures, posts, activities, events and interests with other users in their network.

Electronic commerce is a popular way of selling items (e.g., goods and/or services) to consumers. A typical electronic commerce system may provide user interfaces that enable consumers to browse and/or purchase items from a merchant or seller associated with the electronic commerce system. Item listings can typically be located using a search engine or by browsing item categories or lists. Many individuals maintain accounts with both a social networking service and an electronic commerce system, although these accounts are not traditionally associated with each other.

### BRIEF DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIG. 1 is a block diagram depicting an illustrative operating environment for managing a user account based on information received from a social networking service.

FIG. 2 depicts a general architecture of a computing device for managing a user account based on information received from a social networking service.

FIG. 3 depicts an embodiment of a state flow diagram in which a marketplace system performs an action based at least in part on information received from a social networking service.

FIG. 4 is a flow diagram of an illustrative method for managing a user account based on information received from a social networking service.

FIG. 5 is an illustrative user interface generated by the social networking service that illustrates interactions between the social networking service and the account management service.

FIG. 6 is an illustrative user interface generated by a marketplace system that presents content of an electronic shopping cart that has been updated based at least in part on a social network tag.

### DETAILED DESCRIPTION

Generally described, aspects of the present disclosure relate to managing a user account based on information received from a social networking service. In accordance with aspects of the present disclosure, a user can associate an account on a social networking service with a separate account on an electronic marketplace system, such as a retail website. The electronic marketplace system can define social network tags or identifiers that can be used within the social networking service. The marketplace system can use the social network tags to implement functions or take actions within the marketplace system on behalf of a user. For example, in one instance, an initial microblog message posted by a user on the social networking service can include a uniform resource identifier (“URI”) associated with an item, such as a video game or bicycle, offered for sale on the electronic marketplace system. Within the social networking service, a user can post a microblog message in response to the initial microblog message containing the item information that was initially posted. Within the response message, the user can include a social network tag (e.g., “#addtocart”). The social network tag can be associated with a function that can be implemented by the electronic marketplace system on behalf of the user. The marketplace system may store account association information that associates the user of the social networking system with a user account in the marketplace system. The function associated with a particular social network tag may include, for example, that the electronic marketplace system add the item to a shopping cart associated with the user's account, purchase the item or perform another action associated with the item. The electronic marketplace system can receive the data associated with the user's response message and use the information to implement the desired functionality with respect to the user's marketplace account. The electronic marketplace system can also provide confirmation to the user within the social networking service that the request has been fulfilled.

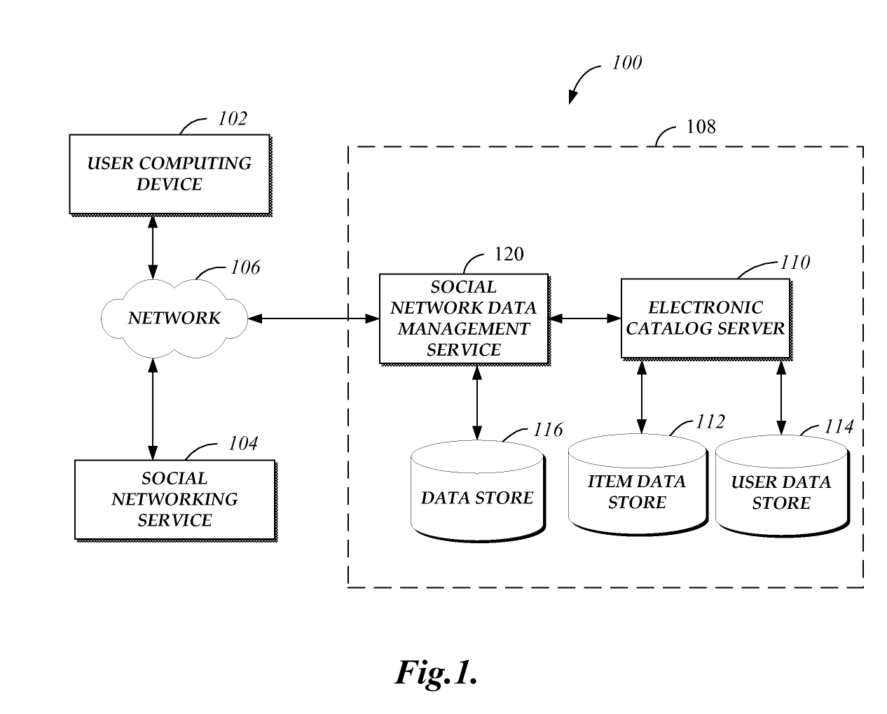

The illustrative operating environment 100 shown in FIG. 1 includes an electronic marketplace system 108 which enables users to browse and place orders for items (such as items listed in an electronic catalog). The marketplace system 108 may include one or more social network data management services 120 that may be used to implement various aspects of the present disclosure, such as receiving and processing information received from a social networking service 104, taking an action with respect to an account of a marketplace user based at least in part on information received from the social networking service 104 and other aspects discussed herein. The marketplace system 108 may also include one or more electronic catalog servers 110 that facilitate electronic browsing and purchasing of items, such as goods and/or services, using various user devices, such as user computing device 102.

In some embodiments, an electronic marketplace system 108, as described herein, may include or be in communication with a data store of information about items that may be listed for sale by sellers, merchants and/or other users, such as item data store 112. The item information in this data store may be viewable by end users through a browsable electronic catalog in which each item may be described in association with a corresponding network page, which can be referred to as an item detail page. Each item detail page may include, for example, an item image and description, customer ratings, customer and professional reviews, sales rank data, lists of related items, and/or other types of supplemental data that may assist consumers in making informed purchase decisions. Users of the system may, in some embodiments, locate specific item detail pages within the electronic catalog by executing search queries, navigating a browse tree and/or using various other navigation techniques. An item detail page may be associated with one or more uniform resource identifiers (“URIs”) that may be interpreted by a browser or other program operating on a computing device in order to present the item details, request the page information from a server or other system, or the like.

The electronic catalog server 110 may be connected to or in communication with an item data store 112 that stores item information regarding a number of items, such as items listed in an electronic catalog as available for browse and/or purchase via the electronic catalog server 110. Item data stored in item data store 112 may include any information related to each item. For example, item data may include, but is not limited to, price, availability, title, item identifier, item image, item description, item attributes, keywords associated with the item, etc. In some embodiments, the item data store 112 may store digital content items (e.g., audiobooks, electronic books, music, movies, multimedia works, text documents, etc.).

The electronic catalog server 110 may also be connected to or in communication with a user data store 114 that stores user data associated with users of the electronic catalog server 110, such as purchase history, browsing history, item reviews and ratings, personal information, user preferences, location information, environment attributes, etc. In different embodiments, each of the item data store 112, user data store 114 and/or data store 116 may be local to the social network data management service 120, may be local to electronic catalog server 110, may be remote from both social network data management service 120 and electronic catalog server 110, and/or may be a network-based service or web service itself.

The social networking service 104 may be any service that allows users to create accounts and publish information that is accessible by other users. The social networking service can include network-based communities where users may associate with other users based on interests, friendship, professional associations, etc. The social networking service 106 may include message boards, user discussion forums, personal blogs, group blogs, etc. Users can share information that is disseminated to other users. Some social networking services support microblog messages or micropost messages (sometimes referred to as “tweets”), that allow a user to publish content on a smaller scale than a typical blog or posting. For example, a microblog message may allow a user to publish only small elements of content such as short sentences, individual images, short videos, URIs and/or other information. Users can also share information via blog messages, status updates, comments (such as comments regarding an article, image, post or other content), media content (e.g., video and/or audio content) or other messaging services available on the social networking service. The messaging services can allow the users to publish any type of content that is supported by the social networking service. The characteristics of particular social networking services can determine how information is shared between user accounts and outside of the social networking service. In some instances, a user account can be a public account that can publically broadcast messages and can make other information associated with the user account available to other users. In some instances, users can have private accounts that limit access to information contained within the user account to a specified group of accounts, such as users who are connected to the given user within a social network.

In the environment shown in FIG. 1, a user of the marketplace system 108 may utilize a user computing device 102 to communicate with the social networking service 104 and/or the marketplace system 108 via a communication network 106, such as the Internet or other communications link. The operating environment 100 can include any number of user computing devices 102. Those skilled in the art will recognize that the user computing device 102 may be any of a number of computing devices that are capable of communicating over a network. For example, the user computing devices can include, but are not limited to, a laptop, personal computer, personal digital assistant (PDA), hybrid PDA/mobile phone, mobile phone, electronic book reader, digital media player, tablet computer, gaming console or controller, kiosk, augmented reality device and the like.

The network 106 may be any wired network, wireless network or combination thereof. In addition, the network 106 may be a personal area network, local area network, wide area network, cable network, satellite network, cellular telephone network, etc. or combination thereof. Protocols and components for communicating via the Internet or any of the other aforementioned types of communication networks are well known to those skilled in the art and are not described in more detail herein.

The marketplace system 108 is depicted in FIG. 1 as operating in a distributed computing environment comprising several computer systems that are interconnected using one or more computer networks. The marketplace system 108 could also operate within a computing environment having a fewer or greater number of components than are illustrated in FIG. 1. Thus, the depiction of marketplace system 108 in FIG. 1 should be taken as illustrative and not limiting to the present disclosure. For example, the marketplace system 108 could implement various Web services components and/or peer-to-peer network configurations to implement at least a portion of the processes described herein.

In brief, the electronic catalog server 110 is generally responsible for providing front-end communication with various user devices, such as user computing device 102, via network 106. The front-end communication provided by the electronic catalog server 110 may include generating text and/or graphics, possibly organized as a user interface using hypertext transfer or other protocols in response to information inquiries received from the various user devices. The electronic catalog server 110 may obtain information on available goods and services from one or more data stores, such as item data store 112, as is done in conventional electronic commerce systems. In certain embodiments, the electronic catalog server 110 may also access item data from other data sources, either internal or external to marketplace system 108.

The social network data management service 120 can manage marketplace user accounts based on information received from social networking service 104. In some embodiments, the social network data management service 120 can manage interactions between a social networking service and a plurality of marketplace systems. For example, the social network data management service 120 can be independent of the marketplace service 108 and provide the services described herein with multiple marketplace systems 108. The social network data management service 120 may be connected to or in communication with data store 116 that may store data received from the social networking service 104. The data can include datasets associated with one or more social network tags and/or other information.

The social network data management service 120 can define characteristics associated with social network tags. The social network tags can be included in microblog messages and/or other types of messages. Characteristics of social network tags can include, for example, the function associated with the social network tag, criteria for implementing the function, and the specific format of the social network tag. A social network tag can be associated with one or more functions that can be implemented within the marketplace system 108. For example, a social network tag can be associated with one or more specific functions implemented within the electronic catalog server 110. The social network tags can be associated with any functionality that is supported and could be implemented on behalf of a user by the marketplace system 108. In some embodiments, the functions associated with the social network tags can create, modify, remove, and/or perform other functions that affect the characteristics or attributes of a user account. For example, in some embodiments, the functions can add an item to an item list associated with a user (which may include, for example, a wish list, an electronic shopping cart, an order or other list), add an item to a shopping cart, purchase an item, upgrade a service, purchase a service, or perform other functionality associated with the marketplace system 108.

The social network data management service 120 can define one or more criteria that need to be satisfied in order to implement the desired functionality associated with the social network tag within the marketplace system 108. The criteria for implementing the function, in some embodiments, may be based at least in part on the characteristics of the function, characteristics of the social networking service 104, characteristics defined by the marketplace system 108, and/or other characteristics. For example, a social network tag can be associated with a function that adds an item to a shopping cart within a user's account. The criteria associated with this social network tag, in one embodiment, may require that a social network microblog message includes a reference to an item available via the marketplace system 108 and that a marketplace account is associated with the social networking account.

The format of the social network tag may be based in part on characteristics of the particular social networking service. In some embodiments, the social networking service defines types of data that may be supported and usable as social network tags with respect to the given social networking service. The social network data management service 120 can also determine a social network tag based on a specific application programming interface (“API”) of the social networking service 104. The social network data management service 120 may define a social network tag based in part on the type of information that can be retrieved from the social networking service 104. As illustrative examples, social network tags can be defined as text data, metadata, metatags, images, and/or other data types. In one example, the social network tag can be a character string. The syntax of the character string can vary depending on the characteristics of the social networking service. In some embodiments, the designated character string may be preceded by a character or symbol (e.g., “#addtocart” or “@addtocart”). The character string can be any text-based symbol and/or alphanumeric character, or combination of symbols and/or alphanumeric characters, that is supported by the social networking service 104 and which can be accessed for processing by the marketplace system. The social network tag may not be exclusively associated with the marketplace system 108.

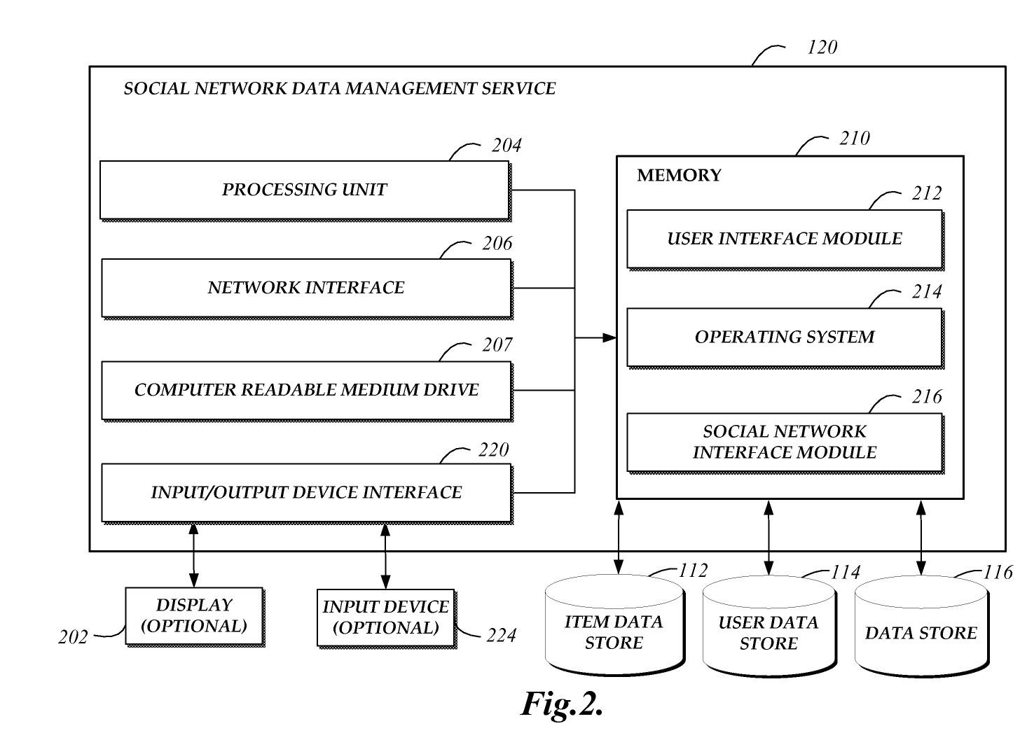

FIG. 2 depicts an example of a general architecture of a social network data management service 120 for managing and processing information associated with one or more social networking services 104. The general architecture of the social network data management service 120 depicted in FIG. 2 includes an arrangement of computer hardware and software components that may be used to implement aspects of the present disclosure. The social network data management service 120 may include many more (or fewer) components than those shown in FIG. 2. It is not necessary, however, that all of these generally conventional components be shown in order to provide an enabling disclosure. As illustrated, the social network data management service 120 may include a network interface 206, a processing unit 204, an input/output device interface 220, a display 202, an input device 224, and a computer readable medium drive 207, all of which may communicate with one another by way of a communication bus. The network interface 206 may provide connectivity to one or more networks or computing systems. The processing unit 204 may thus receive information and instructions from other computing systems or services via a network. The processing unit 204 may also communicate to and from memory 210 and further provide output information for an optional display 202 via the input/output device interface 220. The input/output device interface 220 may also accept input from the optional input device 224, such as a keyboard, mouse, digital pen, microphone, touch screen, etc.

The memory 210 may contain computer program instructions (grouped as modules in some embodiments) that the processing unit 204 executes in order to implement one or more embodiments. The memory 210 generally includes RAM, ROM and/or other persistent, auxiliary or non-transitory computer-readable media. The memory 210 may store an operating system 214 that provides computer program instructions for use by the processing unit 204 in the general administration and operation of the social network data management service 120. The memory 210 may further include computer program instructions and other information for implementing aspects of the present disclosure. For example, in one embodiment, the memory 210 includes a user interface module 212 that generates user interfaces (and/or instructions therefor) for display upon a computing device, e.g., via a navigation interface such as a browser installed on the computing device. In addition, memory 210 may include or communicate with an auxiliary data store 116, user data store 114, item data store 112 and/or one or more other data stores, as discussed above with reference to FIG. 1.

In addition to the user interface module 212, the memory 210 may include a social network interface module 216 that may be executed by the processing unit 204. In one embodiment, the social network interface module 216 implements various aspects of the present disclosure, such as requesting data from one or more social networking services, processing data received from the social networking services, determining actions to perform based on the data received from the social networking services, and other aspects of the disclosure described below. While the social network interface module 216 is shown in FIG. 2 as part of the social network data management service 120, in other embodiments, all or a portion of a social network interface module 216 may be a part of the electronic catalog server 110 and/or a user computing device, such as user computing device 102. For example, in certain embodiments of the present disclosure, the electronic catalog server 110 may include several components that operate similarly to the components illustrated as part of the social network data management service 120, including a user interface module, social network interface module, processing unit, computer readable medium drive, etc. In such embodiments, the electronic catalog server 110 may communicate with a social network services data store, such as data store 116, and the social network data management service 120 may not be needed in certain embodiments. Further, although certain examples are illustrated herein in the context of an electronic catalog server 110, this is not a limitation on the systems and methods described herein.

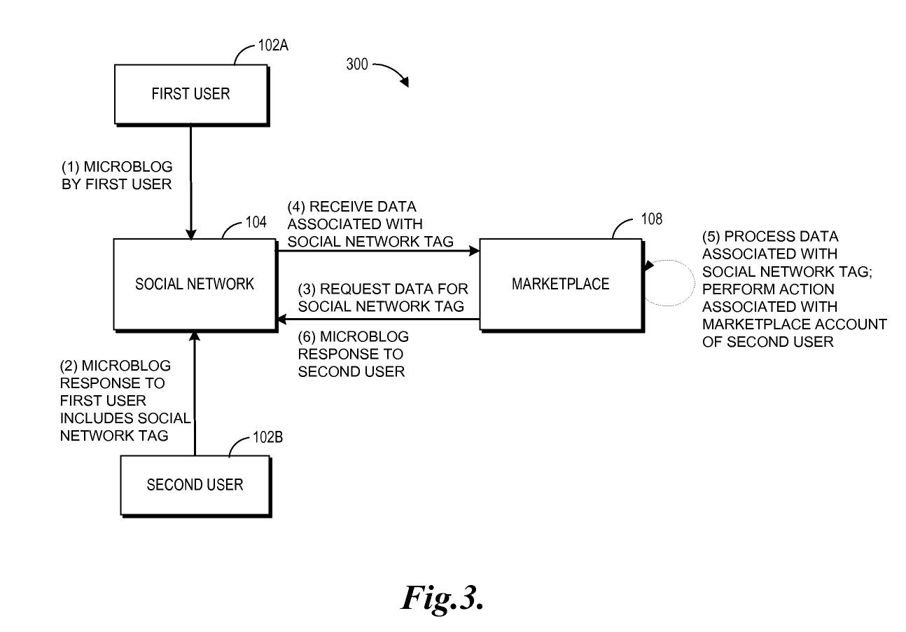

FIG. 3 illustrates an embodiment of a state flow diagram depicting interactions involving a first user 102A, a second user 102B, a social networking service 104, and a marketplace system 108. In the illustrated embodiment, the marketplace system 108 performs an action with respect to a user account associated with the second user 102B based at least in part on information received from the social networking service 104. The information received from the social networking service 104 is associated with a social network tag associated with the action. For illustrative purposes, reference is made to microblog messages; however, the interactions can apply to any micropost message, blog message, status update, comment or other message on a social networking service, regardless of size or character limit. It will be appreciated that, in some embodiments, the illustrative methods described herein may be implemented with respect to any messages posted by users, whether or not such messages are posted in association with a social networking service. For example, aspects of the present disclosure may be applicable to comments or messages posted to a discussion board, page or other content, regardless of whether any user connection data is stored in association with the posting users.

At (1) illustrated in FIG. 3, a first user 102A posts a microblog message, micropost message, blog message, status update, comment or other message on the social networking service 104. For example, the first user may utilize user computing device 102 or another computing device to author a microblog message and send text and/or other information associated with the microblog message to the social networking service 104 to be broadcast, shared or otherwise made accessible to one or more other users. In the illustrated example, the microblog message by the first user 102A includes information that references or identifies an item, such as a product or service, that is available from the marketplace system 108. The information associated with the item may identify the item using text, images, identification numbers, a uniform resource identifier (“URI”) or other identifier, or other information that the marketplace system may use to identify a specific item. In one embodiment, the information that identifies the item is a URI that is associated with a specific item included in an electronic catalog of the marketplace system 108. For example, the URI may correspond to an item detail page for a given item, as described above. In some embodiments, additional information can be encoded within the URI, such as third party affiliate information that can be used by the marketplace system to identify the referral source associated with the URI.

After the first user 102A posts the microblog message on the social networking service 104, the microblog message can be viewed by other members of the social networking service. Depending on the specific characteristics of the social networking service, the microblog message may be publicly available to every user or to a select set of users associated with the first user 102A. For example, according to one embodiment of a social networking service, only users following or otherwise connected to the first user within the social networking service may have permission to access the microblog message of the first user 102A.

At (2), a second user 102B posts a microblog message in response to the microblog message by the first user 102A that includes a social network tag associated with the marketplace system 108. In the illustrated example, the microblog message of the second user 102B specifically references or is otherwise associated with the microblog message of the first user, such as a reply. In the illustrated embodiment, the microblog message of the second user includes a social network tag, which may be represented as text, within the text of the second user's microblog message itself. In other embodiments, the social network tag may be embedded within the metadata of the microblog message and not necessarily included within visual elements of the microblog message. The social network tag can be any identifier that is defined by the marketplace system 108. The social network tag can be used by the marketplace system 108 to identify one or more specific commands, actions or functions that can be performed by the marketplace system 108 on behalf of the second user 102B. In some embodiments, the social network tag can be any type of information (e.g., text data, image data, etc.) capable of being included within the response message of the second user 102B (or associated with metadata of the response message) that can be identified and accessed by the marketplace system 108. In one embodiment, each social network tag may be a text string preceded by a defined symbol or character, such as the text strings “#addtocart,” “#addtowishlist” or any other defined social network tag or text string. Each social network tag defined or recognized by the marketplace system 108 can have different associated functions.

At (3), the marketplace system 108 queries or requests data from the social networking service 104 associated with one or more social network tags and/or associated with one or more users. The structure of the request may be dependent upon the specific social networking service 104 and its associated application program interface (“API”). A social networking service 104 may limit the access that third parties, such as the marketplace system 108, have to information contained within the social networking service 104. For example, a social networking service can limit the information to specific types of queries. In some embodiments, the options that are available to the marketplace system 108 can be used to define the types of social network tags that are used by the marketplace system 108 for a specific social networking service.

The marketplace system 108 can request information from the social network that is associated with the defined social network tags. The requested information can include information that is used by the marketplace system 108 to implement a command or action associated with each social network tag. For example, the query may request information from the response microblog message of the second user that included the social network tag and the microblog message of the first user that did not include the social network tag. In one instance, the social network tag may be the text “#addtocart,” and the marketplace system 108 may request information from the social networking service for all microblog messages that include the text “#addtocart.”

At (4), the marketplace system 108 receives the data associated with the social network tag from the social networking service 104. In some embodiments, a third party service can be utilized to perform the actions associated with requesting and receiving data associated with the social network tags. For example, a dedicated service can continuously aggregate data associated with the social network tags and provide the aggregated data to the marketplace system 108.

At (5), the marketplace system 108 processes the data associated with the social network tag. The marketplace system 108 can filter the data to remove data that does not meet the criteria for executing the function associated with the social network tag. For example, a social network tag defined by the marketplace system 108 may be readily usable by all users of the social networking service and not exclusively associated with the marketplace system 108. In one example, the social network tag is a text string that any user of the social networking service can use. The data associated with a social network tag may be filtered based on specific criteria defined by the marketplace system 108. The data can be grouped into datasets associated with each instance of usage of a social network tag. The data included in the dataset can be defined by the marketplace service, the social networking service, or a combination of both. The marketplace system 108 can determine whether the dataset associated with the social network tag contains the sufficient information for the marketplace system 108 to implement the defined command or function associated with the social network tag. For example, in one embodiment, the marketplace system 108 may require that the microblog message by the second user containing the social network tag be in response to a message from a first user containing a URI associated with a specific item of the marketplace system 108. The marketplace system 108 may reject or ignore datasets that do not satisfy the defined criteria. The marketplace system 108 may define different criteria for each social network tag.

For each dataset that satisfies the criteria associated with the social network tag, the marketplace system 108 can perform the defined function associated with the social network tag. The marketplace system 108 can execute the defined function or action with respect to the marketplace user account associated with the second user. Prior to executing the action in the marketplace account of the second user, the user's social networking service account and marketplace account may be linked, according to some embodiments. For example, in one instance, the social network tag can be “#addtocart.” The function associated with this social network tag may be to add the item identified in the first microblog message to the electronic shopping cart of the marketplace account of the user that responded to the first microblog message. In this instance according to one embodiment, the marketplace system 108 would add the item posted by the first user 102A to the shopping cart for checkout in the marketplace account of the second user 102B. This allows the second user to update his marketplace account without requiring the second user to navigate to a different application and/or marketplace resource page to perform the desired function. The marketplace system 108 can define and implement any number of social network tags in order to perform one or more functions associated with the marketplace system 108.

At (6), the marketplace may optionally post a microblog message response on the social networking service with information confirming that the action requested by the second user 102B has been performed.

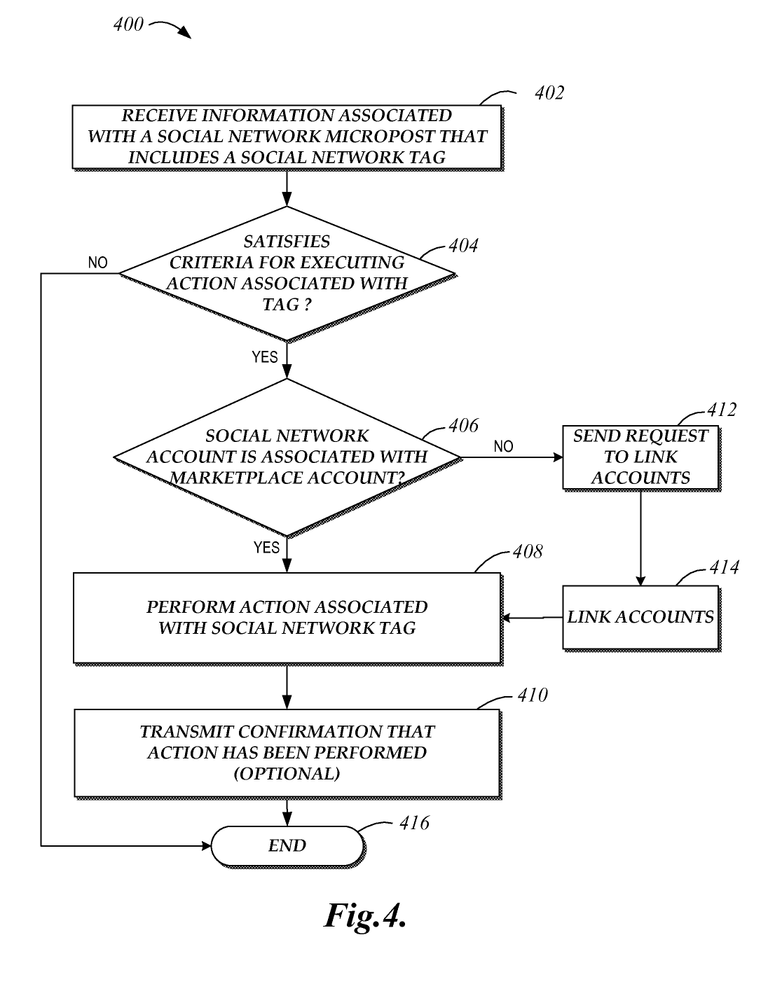

FIG. 4 is a flow diagram of an illustrative method 400, implemented at least in part by the social network interface module 216, for updating a marketplace account of a user and/or taking a marketplace-related action based on a social network tag. For illustrative purposes, reference is made to microblog messages; however, the method 400 can apply to any micropost message, blog message, status update, comment or other message on a social networking service.

At block 402, the marketplace system 108 receives information associated with a social network microblog message that includes a social network tag. In some embodiments, marketplace system 108 can receive the information from a third party service that queries the social networking service 104 and aggregates the data prior to providing the data to the marketplace system 108. In some embodiments, the marketplace system 108 can receive the information directly from the social networking service 104. For example, the marketplace system 108 may periodically query one or more social networking services for microblog messages or other messages that include or reference one or more social network tags. As another example, the marketplace system 108 may automatically receive microblog messages posted by specific users from the social networking service at the time the microblog messages are posted by the users.

At block 404, for the datasets associated with each instance of usage of a social network tag, the marketplace processes the data and determines whether the data included within the dataset satisfies the criteria for executing the action associated with the social network tag. In some embodiments, each social network tag may have different criteria defined by the marketplace system 108 that is required to execute the action associated with the social network tag. For example, in one embodiment, the criteria for a social network tag associated with adding an item to a shopping cart may require a first microblog message that includes an identifier associated with the item and a second microblog message that includes the social network tag. In some embodiments, the microblog message including the social network tag may need to include information in addition to the social network tag. If the information included within the dataset satisfies the criteria for executing the action associated with the social network tag, the process proceeds to block 406. If the information does not satisfy the criteria, the process terminates at block 416.

At block 406, the marketplace system 108 determines whether the social network account is associated with a marketplace account. In order to execute the action associated with the social network tag, the marketplace system 108 can associate the user's social network account with the user's marketplace account. In some embodiments, the marketplace account is associated with the social network account based on a social network identifier included in the dataset. If the user's social network account is associated with the marketplace account the process proceeds to block 408, otherwise the account proceeds to block 412.

At block 412, when the user has not yet associated his social network account with his marketplace account, the marketplace system 108 can send a request to the user to link his social network account to his user account with the marketplace system. At block 414, the marketplace system and/or social networking service may generate one or more user interfaces that enable the user to associate or link his account on the social network to his account with the marketplace system. For example, the user may authorize the marketplace system and/or an application associated with an operator of the marketplace system to access the user's microblog messages and/or other information associated with his social networking service account. In some embodiments in which the user is already logged in to or otherwise authorized to use both his social networking service account and his marketplace system account, a single user interface option may enable the user to link the two accounts. Once the user has linked his accounts, the illustrative method proceeds to block 408.

At block 408, the marketplace system performs the action associated with the social network tag. The action(s) associated with the social network tag are defined by the marketplace system 108. The marketplace system 108 can perform one or more functions based on the social network tag. For example, the social network tag can add an item to a shopping cart, add an item to a wish list, buy an item, or perform other functions that can be performed by the marketplace system 108. For example, a first microblog message can include a URI for an item detail page of a specific item in an electronic catalog of the marketplace system 108, and a response microblog message by a second user can include a social network tag that represents a request to add the referenced item to the shopping cart of the second user. In response, the marketplace system 108 can add the item to the second user's shopping cart within the marketplace account.

In some embodiments, the microblog message can include information in addition to the social network tag within a microblog message that is used by the marketplace system 108 to process the social network tag. For example, the social network tag may represent a request that an item be added to the user's shopping cart. However, the item may have additional attributes that render the request indefinite. For example, a shoe size, color or other item attribute associated with the item may be required prior to adding the item to the shopping cart. These other attributes may not be readily determined by the information included in a URI associated with the item or the social network tag. The user can include additional information relating to the item attributes within the microblog message to clarify these ambiguities. The additional information can affect how the action associated with the social network tag identifier is performed. Additionally, in some embodiments, the user's marketplace account may be associated with specific preferences that identify attributes (e.g., user preferences) associated with classes of items, such as shoe size or a media format for specific items (e.g., video games, movies, etc.). In other embodiments, when an item has multiple variations, such as the item being offered in multiple sizes or colors, the marketplace system may select a single variation and alert the user that the user may wish to make one or more attribute selections before purchasing the item. In some embodiments, multiple social network tags can be included within a microblog message and each action associated with the multiple social network tags can be executed by the marketplace system 108.

After the action is performed, at block 410, a confirmation that the action has been performed can be generated by the marketplace, in some embodiments. The marketplace can send a confirmation to the social networking service, which may in turn be routed to the second user via a communication mechanism that the social networking service uses to communicate with the user. At block 416, the illustrative method ends.

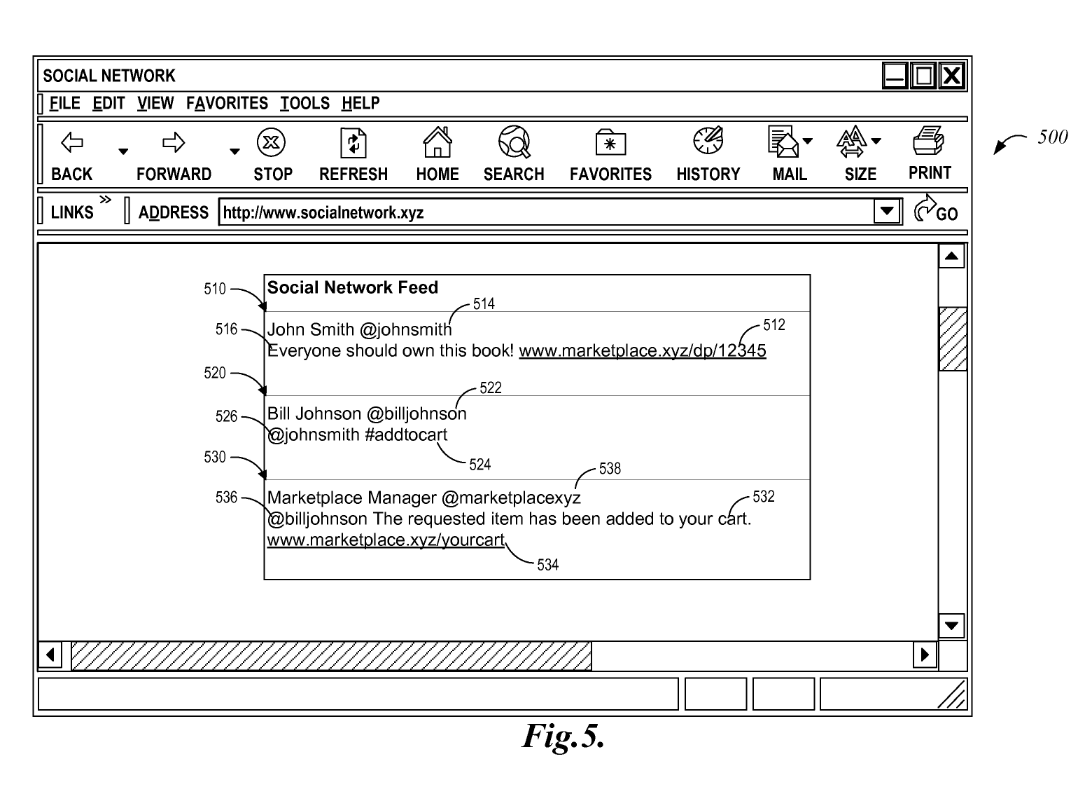

FIG. 5 illustrates an illustrative user interface 500 generated at least in part by a social networking service, such as social networking service 104. In the user interface 500, a first microblog message 510, also referred to as an initial microblog message, is illustrated. The initial microblog message 510 contains a URI 512 for an item that is included within the microblog message. The initial microblog message 510 also includes a first user identifier 514 and additional information 516. The information can be provided in any data format, for example, the information could be text-based, images, video, audio or other types of information that is supported by the social networking service. The user interface 500 also includes a second microblog message 520, also referred to as a reply microblog message. The reply microblog message 520 has user identifier information 522 associated with a second user account. The reply microblog message 520 also includes at least one social network tag 524. In the illustrated embodiment, the social network tag is the text string “#addtocart.” The reply microblog message can also identify the user associated with the initial microblog message 510. In this embodiment, the reply is to a user identified by “@johnsmith,” which is a handle or other user identifier associated with a user account of the initial microblog message within the social networking service. Depending on the specific characteristics, the identifier of the initial microblog message 510 within the reply microblog message 520 information can be omitted. The third microblog message, also referred to as a confirmation microblog message 530, is provided by a user account associated with the marketplace service. The confirmation microblog message can include an identifier associated with the marketplace service 538 and can include additional information that is posted by the management service 532. In the illustrated embodiment, a URI 534 is included that may be selected by the second user to view the contents of his shopping cart, which could include the item referenced by the URI in the initial microblog message.

The user interface 500 generally illustrates a sample embodiment of a user interface that is generated by the social networking service 104 after the social network data management service 120 updates the user account based on the social network tag. It will be appreciated that a number of variations are possible in such a user interface depending on the given social networking service, the functionality desired and/or other factors.

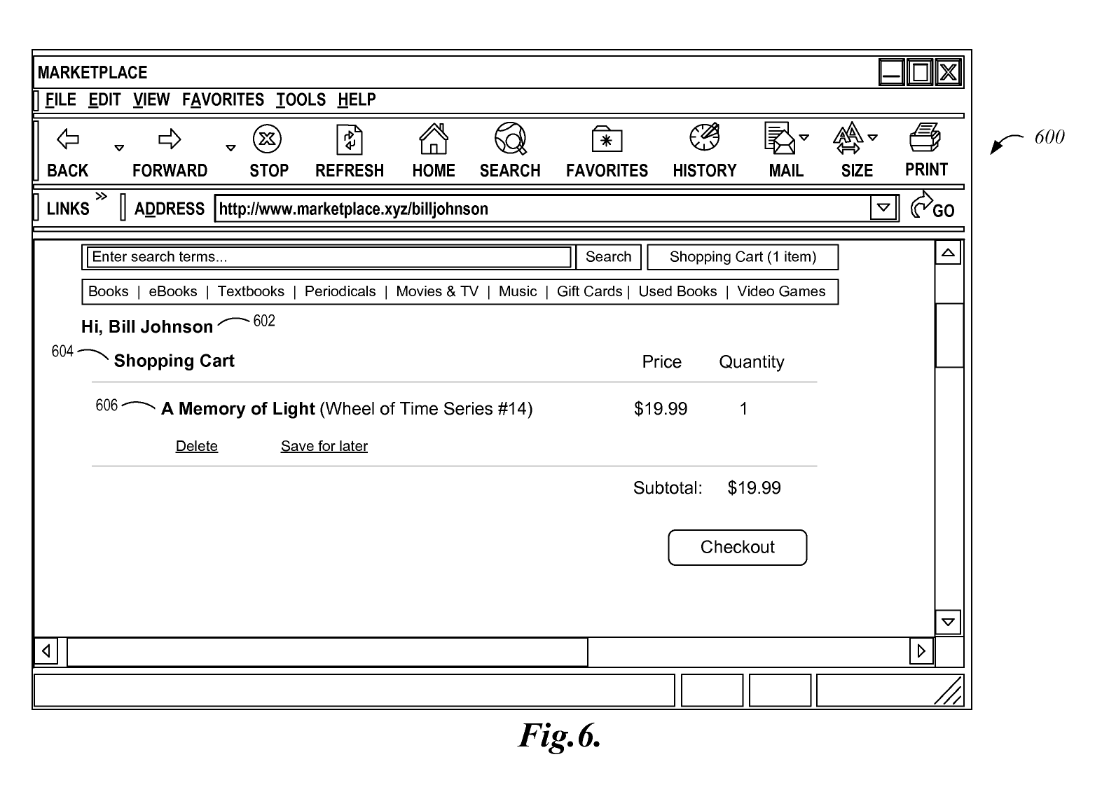

FIG. 6 illustrates an illustrative user interface 600 generated at least in part by a marketplace system, such as marketplace system 108. The user interface 600 may be generated after an action taken by the marketplace system based on the social network tag (in this example, “#addtocart”) used in association with the social networking service account in FIG. 5. The user interface illustrates a shopping cart 604 associated with the marketplace user account 602, where the shopping cart includes the added item 606. The marketplace user account 602 may have been previously linked to or associated with the social networking service user account 522 in FIG. 5. In the illustrated embodiment, the item 606 may have been added to the shopping cart 604 by the marketplace system 108 based at least in part on the use of the “#addtocart” social network tag and the marketplace system 108 determining that item 606 corresponds to the item identifier 512 in FIG. 5.

The user interface 600 generally illustrates a sample embodiment of a user interface that is generated by the marketplace service 108 after the social network data management service 120 updates the user account based on the social network tag. It will be appreciated that a number of variations are possible in such a user interface depending on the given marketplace system, the functionality desired and/or other factors.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm elements described in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A system comprising:
an electronic data store configured to at least store user account data associated with each of a plurality of user accounts of a marketplace system; and
a computing system comprising one or more hardware computing devices, said computing system in communication with the electronic data store and configured to at least:
receive data associated with a social network tag from a social networking service, the data comprising: (a) a first microblog message that includes information identifying an item, and (b) a second microblog message responsive to the first message and posted by a user identified by a social network user account identifier, wherein the second microblog message includes the social network tag;
determine that the data associated with the social network tag satisfies a predetermined criterion for implementing an action associated with the social network tag in the marketplace system; and
based at least in part on the determination that the data satisfies the predetermined criterion:
identify a user account of the plurality of user accounts of the marketplace system that is linked to the social network user account identifier; and
add the item to an item list associated with the identified user account of the marketplace system.

2. The system of claim 1, wherein the item list is associated with an electronic shopping cart.

3. The system of claim 2, wherein the computing system is further configured to transmit an update to the social networking service indicating that the item has been added to the electronic shopping cart.

4. A computer-implemented method comprising:
as implemented by one or more computing devices configured with specific executable instructions,
receiving information associated with a social network identifier, the information comprising a message that includes the social network identifier provided to a first service in association with a first user account of the first service, wherein the first user account is identified by a user account identifier;
determining that the information associated with the social network identifier satisfies a criterion for executing an action associated with the social network identifier in association with a second service;
based at least in part on the determination that the criterion is satisfied, identifying a second user account associated with the second service that is linked to the user account identifier; and
performing the action associated with the social network identifier with respect to the second service based at least in part on the received information associated with the social network identifier, wherein the action modifies at least one characteristic of the second user account.

5. The computer-implemented method of claim 4 further comprising transmitting an update to the first service indicating that the action has been performed.

6. The computer-implemented method of claim 4, wherein the second service is an electronic marketplace.

7. The computer-implemented method of claim 4, wherein the information associated with the social network identifier further comprises an item identifier that identifies an item in an electronic marketplace.

8. The computer-implemented method of claim 7, wherein the action comprises adding the item to an electronic shopping cart associated with the second user account.

9. The computer-implemented method of claim 4, wherein the first service is a social networking service.

10. The computer-implemented method of claim 4, wherein the information associated with the social network identifier is received from a social networking service.

11. The computer-implemented method of claim 4, wherein the information associated with the social network identifier is received from a third party.

12. The computer-implemented method of claim 4, wherein the social network identifier is a character string.

13. A computer-readable, non-transitory storage medium storing computer executable instructions that, when executed by one or more computing devices, configure the one or more computing devices to perform operations comprising:
receiving information associated with a social network identifier, the information comprising a message provided to a first service in association with a first user account of the first service, wherein the message includes the social network identifier;
identifying a second user account that is linked to the first user account, wherein the second user account is associated with a second service; and
performing an action within the second service with respect to the second user account based at least in part on the received information, wherein the action modifies at least one characteristic of the second user account.

14. The computer-readable, non-transitory storage medium of claim 13, wherein the first user account and the second user account belong to the same user.

15. The computer-readable, non-transitory storage medium of claim 13, wherein the operations further comprise transmitting an update to the first service indicating that the action has been performed.

16. The computer-readable, non-transitory storage medium of claim 13, wherein the second service is an electronic marketplace.

17. The computer-readable, non-transitory storage medium of claim 16, wherein the information associated with the social network identifier further comprises an item identifier that identifies an item in the electronic marketplace.

18. The computer-readable, non-transitory storage medium of claim 13, wherein the action comprises adding the item to an electronic shopping cart associated with the second user account.

19. The computer-readable, non-transitory storage medium of claim 13, wherein the action comprises purchasing the item based at least in part on preferences associated with the second user account.

20. A system comprising:
an electronic data store configured to at least store user account data associated with each of a plurality of user accounts of a marketplace system; and
a computing system comprising one or more hardware computing devices, said computing system in communication with the electronic data store and configured to at least:
receive data associated with a social network identifier from a social networking service, the data indicating that a user provided the social network identifier to a first account of the social networking service;
determine that the data associated with the social network identifier satisfies a criterion for implementing at least one action with respect to an account of the marketplace system; and
based at least in part on the determination that the data associated with the social network identifier satisfies the criterion, perform an action associated with a second account of the user, wherein the second account is one of the plurality of user accounts of the marketplace system, wherein the action modifies at least one characteristic of the second account.

21. The system of claim 20, wherein the social network identifier comprises a character string.

22. The system of claim 20, wherein the data associated with the social network identifier further comprises an item identifier that identifies an item in the marketplace system.

23. The system of claim 20, wherein the action comprises adding an item to an electronic shopping cart associated with the second account.
